(19) United States
(12) Patent Application Publication
(10) Pub. No.: US 2024/0405237 A1
(43) Pub. Date: Dec. 5, 2024

(54) FUEL CELL SYSTEM AND METHOD OF OPERATING A FUEL CELL SYSTEM

(71) Applicant: Purem GmbH, Neunkirchen (DE)

(72) Inventor: Gerd Gaiser, Reutlingen (DE)

(21) Appl. No.: 18/678,773

(22) Filed: May 30, 2024

(30) Foreign Application Priority Data
May 30, 2023 (DE) 10 2023 114 076.0

(51) Int. Cl. H01M 8/04746; H01M 8/04119; H01M 8/04828

(52) U.S. Cl. CPC H01M 8/04753; H01M 8/04126; H01M 8/04156; H01M 8/04835; H01M 2250/20

(57) ABSTRACT

A fuel cell system includes a fuel cell, an anode region which is to be fed with hydrogen at an anode inlet of the fuel cell, a cathode region which is to be fed with oxygen via a cathode inlet conduit at a cathode inlet of the fuel cell, a cathode gas conveyor for conveying cathode gas into the cathode inlet conduit, an anode outlet conduit which accepts anode offgas at an anode outlet of the fuel cell, a catalytic converter through which the anode offgas can flow in the anode outlet conduit, a cathode outlet conduit which accepts cathode offgas at a cathode outlet of the fuel cell, and a cathode branch conduit that connects the cathode inlet conduit to the anode outlet conduit upstream of the catalytic converter.

### CROSS-REFERENCE TO RELATED APPLICATIONS

This application claims priority of German patent application no. 10 2023 114 076.0, filed May 30, 2023, the entire content of which is incorporated herein by reference.

### TECHNICAL FIELD

The present disclosure relates to a fuel cell system that can be utilized, for example, in an electrically operated vehicle to generate the electrical energy required for operation of the vehicle.

### BACKGROUND

In the case of such fuel cell systems having one or more fuel cells in the form of PEM fuel cells, for example, purge operations are conducted to some degree at the start of fuel cell operation and also to some degree during fuel cell operation. In these purge operations, the anode region of a fuel cell is purged with hydrogen which is introduced into the anode end region of a fuel cell and released again from an anode outlet region, such that air and/or nitrogen that accumulate in the anode region are discharged therefrom in order thus to ensure efficient fuel cell operation with unimpaired hydrogen concentration in the anode region.

The hydrogen released from the anode region with the anode gas in such a purge operation is a fundamentally environmentally harmful gas, and the release of hydrogen to the environment can lead to a potentially critical situation in terms of explosion risk.

### SUMMARY

It is an object of the present disclosure, in a simple and compact construction configuration of a fuel cell system, to reliably minimize the amount of hydrogen released to the environment.

In a first aspect of the present disclosure, this object is achieved by a fuel cell system, especially for a vehicle, including:
at least one fuel cell,
an anode region which is to be fed with hydrogen at an anode inlet region of the at least one fuel cell,
a cathode region which is to be fed with oxygen via a cathode inlet conduit at a cathode inlet region of the at least one fuel cell,
a cathode gas conveying arrangement for conveying cathode gas into the cathode inlet conduit,
an anode outlet conduit which accepts anode offgas at an anode outlet region of the at least one fuel cell,
at least one catalyst unit through which the anode offgas can flow in the anode outlet conduit,
a cathode outlet conduit which accepts cathode offgas at a cathode outlet region of the at least one fuel cell,
a cathode branch conduit that connects the cathode inlet conduit to the anode outlet conduit upstream of at least one catalyst unit.

A significant contribution to reduction in the level of hydrogen reduced to the environment is made by a catalyst unit where, especially in the case of performance of purge operations, hydrogen released at the anode outlet region is converted to water in a catalytic reaction with oxygen. The oxygen required for this catalytic conversion is provided in that a portion of the oxygen-containing cathode gas which is to be fed to the cathode inlet region via the cathode gas conveying arrangement is branched off and introduced together with the anode offgas into the at least one catalyst unit or, if two or more such catalyst units are provided, into at least one of the catalyst units.

Since, in the case of a fuel cell system constructed in accordance with the disclosure, a portion of the cathode gas having a high oxygen content and a low moisture content/low water content is mixed with the anode offgas, a comparatively small gas volume flow rate to be conducted through the at least one catalyst unit is required to achieve substantially complete conversion of the hydrogen present in the anode offgas with atmospheric oxygen to give water. This permits provision of the catalyst unit with a comparatively small catalyst volume or a small catalyst surface area, which allows firstly build size and secondly build costs to be kept low. Moreover, an excessively large mass flow rate through the at least one catalyst unit that leads to a relatively high pressure drop is avoided.

When the cathode branch conduit is branched off from the cathode inlet conduit downstream of the cathode gas conveying arrangement, cathode gas that has already been heated by the compression in the cathode gas conveying arrangement is branched off before introduction into the cathode region and supplied to the at least one cathode unit. This achieves improved conversion characteristics of the at least one catalyst unit in the catalytic conversion of hydrogen and oxygen to water.

For defined adjustment of the proportion of the portion of cathode gas directed into the cathode branch conduit, it is proposed that the cathode branch conduit be assigned a flow-regulating arrangement for elective closure of the cathode branch conduit to flow of cathode gas and opening of the cathode branch conduit for passage of a portion of the cathode gas introduced into the cathode inlet conduit into the cathode branch conduit.

It is advantageously possible here for the proportion of the cathode gas introduced into the cathode branch conduit to be variable via the flow-regulating arrangement.

In order to be able to provide the cathode gas with the required or advantageous water content for efficient fuel cell operation in the cathode region of the at least one fuel cell, there may be a cathode gas moistening arrangement disposed downstream of a branch in the cathode branch conduit in the cathode inlet conduit. In the cathode gas moistening arrangement, water or water vapor may be added to the cathode gas. Since this addition of water or water vapor is effected downstream of the branch of the portion of the cathode gas to be directed to the at least one catalyst unit, the portion of the cathode gas to be mixed with the anode offgas has only a comparatively low water content, which in turn has the effect that the mixture of anode offgas and cathode gas introduced into the at least one catalyst unit also has a comparatively low moisture content or a comparatively low water content. This has an advantageous effect on the conversion characteristics of the catalyst unit in performance of the catalytic reaction and prevents excessively rapid aging of the catalytically active material in particular.

In the fuel cell system constructed in accordance with the disclosure, a fuel cell offgas system may be provided to accept the cathode offgas and the mixture of the anode offgas with the portion of the cathode gas that has been branched off from the cathode inlet conduit, the mixture having been released from the at least one catalyst unit after performance of the catalytic reaction.

For example, the fuel cell offgas system may include a demoisturizing arrangement in order to withdraw further moisture or water from the fuel cell offgas before release to the environment. Alternatively or additionally, the fuel cell offgas system may include a sound absorber in order to suppress the release of noise that may arise, for example, in the region of a compressor that conveys air into the cathode region into the environment.

An alternatively configured fuel cell system of the disclosure, especially for a vehicle, includes:
at least one fuel cell,
an anode region which is to be fed with hydrogen at an anode inlet region of the at least one fuel cell,
a cathode region which is to be fed with oxygen via a cathode inlet conduit at a cathode inlet region of the at least one fuel cell,
a cathode gas conveying arrangement for conveying cathode gas into the cathode inlet conduit,
an anode outlet conduit which accepts anode offgas at an anode outlet region of the at least one fuel cell,
at least one catalyst unit through which the anode gas can flow in the anode outlet conduit,
a cathode outlet conduit which accepts cathode offgas at a cathode outlet region of the at least one fuel cell,
an air inlet conduit for introduction of air conveyed through a fan as mixed gas into the anode outlet conduit upstream of at least one catalyst unit.

In this type of configuration of a fuel cell system, it is not the case that a portion of the air conveyed through the cathode gas conveying arrangement as cathode gas is branched off and directed in the direction of the at least one catalyst unit; instead, for example, external air supplied from the outside that fundamentally should not be fed into the fuel cell process is utilized as mixed gas and added to the anode offgas downstream of the at least one catalyst unit. It is thus fundamentally possible to achieve the same advantages as elucidated above.

It should be pointed out that, in the case of this fuel cell system too, all advantageous further configurations that have been elucidated above with reference to the former fuel cell system may be envisaged individually or in combination.

In a further aspect of the present disclosure, the object is achieved by a method of operating a fuel cell system, especially a fuel cell system constructed in accordance with the disclosure, where anode offgas released at an anode outlet region of a fuel cell is directed through at least one catalyst unit to reduce the hydrogen content in the anode offgas, and a portion of cathode gas supplied to a cathode inlet region of a fuel cell or air as mixed gas is added to the anode offgas upstream of at least one catalyst unit.

For adjustment to various states of operation, the portion of the cathode offgas added to the anode offgas or the amount of air added to the anode offgas as mixed gas may be variable.

In particular, it may be the case that the amount of the cathode gas added to the anode offgas or of the air as mixed gas is adjusted depending on the hydrogen content in the anode offgas released at the anode outlet region.

For efficient catalytic conversion with minimized volume flow rate through the at least one catalyst unit, it is proposed that the amount of the cathode gas added to the anode offgas or of the air as mixed gas be adjusted such that an at least stoichiometric, preferably superstoichiometric, oxygen/hydrogen ratio is provided for catalytic reaction in the at least one catalyst unit. Especially operation of the at least one catalyst unit with a superstoichiometric oxygen/hydrogen ratio ensures that essentially all the hydrogen present in the anode offgas can be converted to water.

The occurrence of a critical hydrogen concentration with regard to the occurrence of an explosive hydrogen/oxygen gas reaction in the region of the at least one catalyst unit in the mixture of anode offgas and cathode gas directed through the at least one catalyst unit can be avoided in that the amount of the cathode gas added to the anode offgas or of the air as mixed gas is adjusted such that the mixture of anode offgas and cathode gas fed to the at least one catalyst unit has a hydrogen content below a threshold hydrogen content.

It is particularly advantageous here when the threshold hydrogen content is in the range from 4% by volume to 8% by volume, and hence an ignition ratio that permits such a reaction is not attained.

For further treatment of the various offgas streams, the cathode offgas leaving the at least one fuel cell at a cathode outlet region and the mixture that leaves the at least one catalyst unit after performance of the catalytic reaction of the anode offgas and of the portion of the cathode gas added to the anode offgas or of the air added as mixed gas are directed into a fuel cell offgas system. In such a fuel cell offgas system, further moisture or further water may be withdrawn from this flowing gas mixture. It is also possible for such a fuel cell offgas system to include a sound absorber in order to suppress the release of noise which may arise in particular in the region of the compressor that conveys air into the cathode region to the outside.

### BRIEF DESCRIPTION OF DRAWINGS

The invention will now be described with reference to the drawings wherein:

FIG. 1 shows a fuel cell system in a schematic representation; and,

FIG. 2 shows an alternative mode of configuration of the fuel cell system.

### DETAILED DESCRIPTION

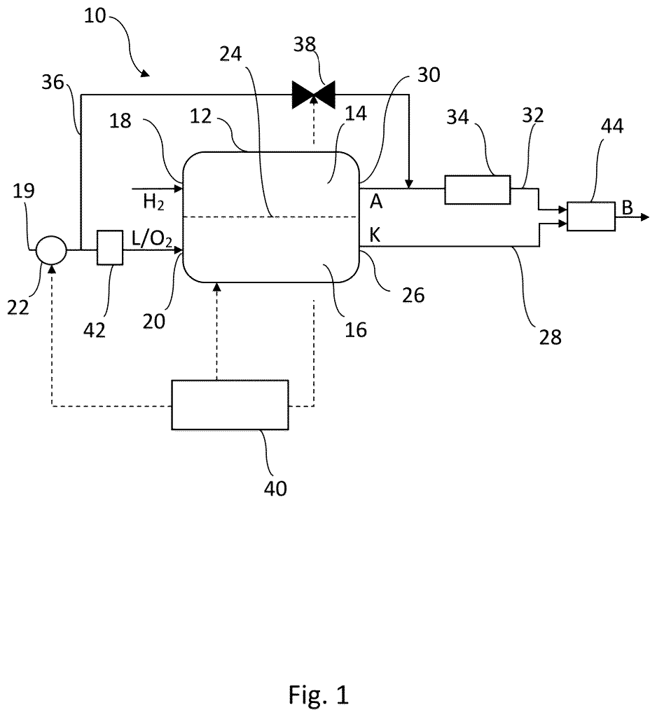

In FIG. 1, a fuel cell system used in a vehicle for generation of electrical energy for example is generally labeled 10. The fuel cell system 10 includes, as central unit, a fuel cell 12 in the form of a PEM fuel cell, for example, or a fuel cell stack, having an anode region 14 and a cathode region 16. The anode region 14 is supplied at an anode inlet region 18 with gaseous hydrogen H₂, for example from a cryogenic hydrogen tank. Via a cathode inlet conduit 19, via a cathode gas conveying arrangement 22 in the form of a compressor, for example, the cathode region 16 is supplied at a cathode inlet region 22 with air L as cathode gas and hence oxygen O₂ present in the air. In fuel cell operation of the fuel cell 12, hydrogen protons diffuse through the membrane 24 of the fuel cell 12 into the cathode region 16, where they react with oxygen introduced into the cathode region 16 to give water, which is released together with residual oxygen and nitrogen present in the air L supplied to the cathode region 16 into a cathode outlet conduit 28 at a cathode outlet region 26.

In order to remove air, that is, essentially oxygen and nitrogen, accumulating in the anode region 14 from the anode region 14 when the fuel cell 12 is not activated, or to discharge nitrogen that accumulates in the anode region 14 via diffusion through the membrane 24 from the anode region 14 during fuel cell operation, purge operations are conducted, for example, before startup of the fuel cell 12 or during fuel cell operation, in which an anode outlet region 30 is opened and the anode region 14 is purged by hydrogen introduced into the anode region 14, or nitrogen and/or oxygen accumulating therein are directed from the anode region 14 via the anode outlet region 30 into an anode outlet conduit 32.

The anode offgas A which is released in particular in such purge operations in the anode outlet conduit 32 contains hydrogen, the release of which to the environment is fundamentally undesirable. For that reason, a catalyst unit 34 is disposed in the anode outlet conduit 32, in which the hydrogen present in the anode offgas A is reacted with oxygen to give water in a catalytic reaction.

In order to be able to provide the amount of oxygen required for this catalytic reaction, a cathode branch conduit 36 branches off from the cathode inlet conduit 19 downstream of the compressor 22. The cathode branch conduit 36 opens into the anode outlet conduit 32 downstream of the catalyst unit 34. In the cathode branch conduit 36, a flow-directing arrangement 36 in the form of a valve or flow flap or the like is provided. A portion of the cathode gas L conveyed by the compressor 22 into the cathode inlet conduit 19 can be directed via the cathode branch conduit 36 and the flow-regulating arrangement 38 and can be introduced via the latter into the anode outlet conduit 32 and mixed with the anode offgas A released at the anode outlet region 30 upstream of the catalyst unit 34.

For defined adjustment of the amount of the cathode gas L directed via the cathode branch conduit 38 into the anode outlet conduit 32 and hence also into the catalyst unit 34, the flow-regulating arrangement 38 is subject to actuation by an actuation unit 40, which can also be utilized for actuation of the fuel cell 12 itself or the compressor 22.

In the cathode inlet conduit 19, downstream of the compressor 22 and especially also downstream of the branch of the cathode branch conduit 36 from the cathode inlet conduit 19, a cathode gas moistening arrangement 42 may be provided. Via the cathode gas moistening arrangement 42, water or water vapor can be added to the portion of the cathode gas L introduced into the cathode region 16 at the cathode inlet region 20, which is advantageous or required for the fuel cell process to be conducted in the fuel cell 12.

If a purge operation is to be conducted, it is possible in unchanged operation of the compressor 22, for example, and hence with an unchanged amount of air introduced into the cathode region 16 as cathode gas L, to actuate a valve (not shown) assigned to the anode outlet region 30 in order to open it and to allow the anode offgas A to flow into the anode outlet conduit 32. The flow-regulating arrangement 38 can be actuated with synchronization to the introduction of the hydrogen-containing anode offgas A into the anode outlet conduit 32 in such a way that a suitable amount of the cathode gas L is branched off from the cathode inlet conduit 19 and introduced into the anode outlet conduit 32.

In order to ensure that there is not at any time too small an amount of oxygen present in the catalyst unit 34 for the performance of the catalytic reaction, it may be the case, for example, that the flow-regulating arrangement 38, even before the directing of hydrogen-containing anode offgas A into the anode outlet conduit 32, feeds a portion of the cathode gas L via the cathode branch conduit 36 into the anode outlet conduit 32 and hence into the catalyst unit 34. With an amount of hydrogen released from the anode region 14 that then increases in the purge operation, a hydrogen/oxygen mixture suitable for complete conversion of the hydrogen is established in the catalyst unit 34. Since the level of the amount or concentration of hydrogen in the anode offgas A is generally also known, it is also possible to ensure via corresponding actuation of the flow-regulating arrangement 38 that the amount of cathode gas L suitable for the establishment of a defined ratio of hydrogen to oxygen is branched off from the cathode inlet conduit 19.

The first important factor in the performance of the catalytic reaction in the catalyst unit 34 is that essentially no hydrogen that has not reacted with oxygen to give water leaves the catalyst unit. This means that the hydrogen/oxygen ratio must be at least stoichiometric. In order to reliably prevent the occurrence of unconverted hydrogen, the oxygen/hydrogen ratio is preferably superstoichiometric, such that the reaction can proceed with an excess of oxygen.

Moreover, it has to be ensured that the percentage by volume of hydrogen in the mixture of anode offgas A and cathode gas L which is fed to the catalyst unit 34 is sufficiently low that an ignition ratio that entails the risk of a hydrogen/oxygen explosion is not attained. For that reason, it is advantageous when the amount of the cathode gas L branched off from the cathode gas L is adjusted such that, taking account of the expected hydrogen content in the anode offgas A in a purge operation, the hydrogen content in the mixture of anode offgas A and cathode offgas K which is then generated does not exceed a threshold hydrogen content in the range from 4% by volume to 8% by volume. It is possible here in particular to determine the amount of the cathode gas L added to the anode offgas A such that the temperature that arises in the catalyst unit owing to the heat of reaction when the catalytic reaction is in progress lies within an optimal range that assists this reaction.

The anode offgas A leaving the catalyst unit 34, which ideally contains virtually no hydrogen but does contain water, can be fed together with the cathode offgas K flowing within the cathode outlet conduit 28 to a fuel cell offgas system 44, in which, for example, water can be withdrawn from the mixture of anode offgas A and cathode offgas K that flows through it. It is also possible for the fuel cell offgas system 42 to contain one or more sound absorbers, via which it is then possible to emit the fuel cell offgas B essentially free of hydrogen and with only a comparatively low water content to the environment.

The fuel cell system of the disclosure, with its simple configuration in terms of construction, reliably ensures that hydrogen emitted especially during purge operations from the anode region of one or more fuel cells can be converted reliably to water in a catalytic reaction with oxygen. Since the anode offgas is mixed only with a portion of the cathode gas to be fed to the cathode inlet region, the volume flow rate put through the catalyst unit is comparatively small, which also contributes to a smaller and hence less costly construction of the catalyst unit.

The operation of the catalyst unit is particularly advantageous in that the portion of the cathode gas supplied thereto is compressed and heated by the compression process in the compressor, such that a uniformly heated mixture of cathode gas or air and anode offgas is introduced into the catalyst unit. The temperature that has also been elevated as a result in the region of the catalyst unit promotes the catalytic conversion of hydrogen and oxygen to water. The branching-off on the portion of the cathode gas to be fed to the catalyst unit upstream of the cathode gas moistening arrangement also ensures that the mixture of anode offgas and cathode gas fed to the catalyst unit has a comparatively low moisture content or comparatively low water content, which reduces the hydrothermal aging of the catalyst unit or of the catalytically active material thereof and promotes the process of catalytic conversion of hydrogen and oxygen to water. Since, moreover, a sufficiently high concentration of hydrogen can be provided for the catalytic conversion, this leads to a greater adiabatic temperature increase and hence to a higher reaction rate, which can increase the efficiency of the catalyst unit.

By virtue of the synchronization of the supply of anode offgas and cathode gas to the catalyst unit, it is possible to ensure that essentially no hydrogen is released to the environment before, during or after performance of purge operations. For this purpose, even before the opening of the anode outlet region, in the performance of a purge operation, cathode gas can be introduced into the anode offgas conduit, also in order to thermally condition the catalyst unit via the heated cathode gas. After the purge operation has ended, the introduction of cathode gas can at first be continued briefly, which in particular also assists the discharge of water that possibly collects in the catalyst unit and hence also contributes to avoidance of excessive hydrothermally induced aging of the catalyst unit. Since advantageously no cathode gas is fed into the anode offgas conduit between the purge operations, it is possible to keep the catalyst unit at an optimal temperature in these phases. At the same time, between the purge operations, the amount of the cathode gas to be conveyed through the cathode gas conveying arrangement is reduced, or limited to the amount required for the performance of the fuel cell process. This permits use of a cathode gas conveying arrangement of comparatively small dimensions.

Since, during the performance of a purge operation, in which there is generally a drop in the pressure in the anode region because of the opening of the anode outlet region, there is a portion of the cathode gas which is branched off and not introduced into the cathode region, there will also be a drop in the pressure in the cathode region, such that operation of the cathode gas conveying arrangement can be continued unchanged without specific actuation measures and without any change in the actuation thereof, but nonuniform stress on a fuel cell membrane that could possibly lead to damage as a result of significantly different pressure ratios in the anode region and in the cathode region can be avoided.

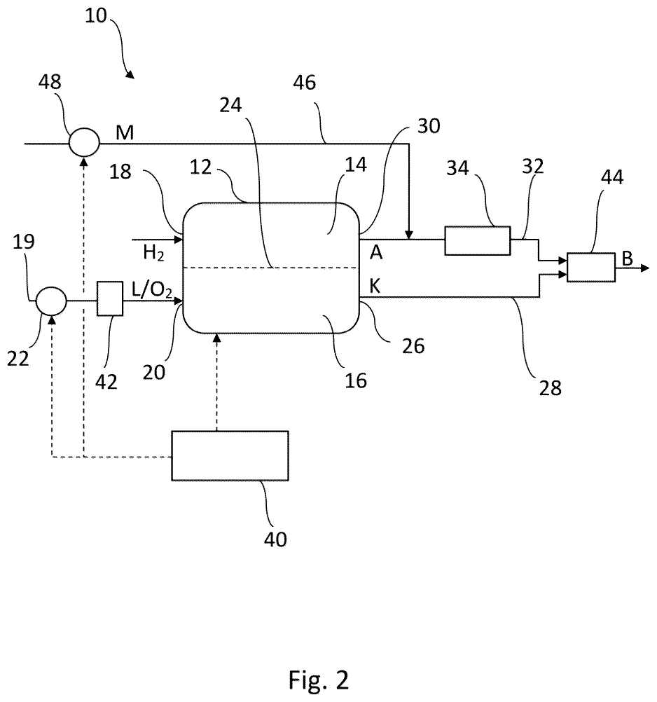

One alternative mode of configuration of such a fuel cell system 10 is shown in FIG. 2. The construction thereof corresponds essentially to the construction described above with reference to FIG. 1, and so reference may be made to these details.

In the fuel cell system 10 of FIG. 2, it is not the case that a portion of the air conveyed by the compressor 22 as cathode gas L is added to the anode offgas A in order to achieve the above-described process of catalytic conversion of hydrogen present in the anode offgas A with atmospheric oxygen. Instead, via a fan 48 disposed in an air conduit 46, which may simultaneously be actuated by the actuation unit 40, irrespective of the conveying of the cathode gas L to the cathode region 16, air as mixed gas M and hence the oxygen present therein is introduced into the anode offgas stream.

In this fuel cell system 10, in the manner described above with reference to the fuel cell system of FIG. 1, or using the same actuation or control measures, it is likewise possible to achieve efficient catalytic conversion, avoiding the output of hydrogen to the environment, in the catalyst unit 34. Since the air is fed in downstream of the anode region 14, there exists only a comparatively small backpressure, such that even a fan of comparatively small dimensions 48 can be utilized for conveying of this air.

It is understood that the foregoing description is that of the preferred embodiments of the invention and that various changes and modifications may be made thereto without departing from the spirit and scope of the invention as defined in the appended claims.

1. A fuel cell system comprising:
a fuel cell having an anode region and a cathode region;
said fuel cell defining an anode inlet to permit feeding said anode region with hydrogen;
a cathode inlet conduit;
said fuel cell defining a cathode inlet to permit feeding said cathode region with oxygen at said cathode inlet via said cathode inlet conduit;
a cathode gas conveyor for conveying cathode gas into said cathode inlet conduit;
said fuel cell defining an anode outlet and a cathode outlet;
an anode outlet conduit for receiving anode offgas at said anode outlet;
a catalytic converter wherethrough said anode offgas flows in said anode outlet conduit;
a cathode outlet conduit for receiving cathode offgas at said cathode outlet of said fuel cell; and,
a cathode branch conduit connecting said cathode inlet conduit to said anode outlet conduit upstream of said catalytic converter.

2. The fuel cell system of claim 1, wherein said cathode branch conduit branches off from said cathode inlet conduit downstream of said cathode gas conveyor.

3. The fuel cell system of claim 1, further comprising: a flow regulator assigned to said cathode branch conduit to selectively close said cathode branch conduit against a through flowing with said cathode gas and to open said cathode branch conduit for passing a portion of said cathode gas introduced into said cathode inlet conduit into said cathode branch conduit.

4. The fuel cell system of claim 3, wherein a proportion of said cathode gas introduced into said cathode branch conduit is variable via said flow regulator.

5. The fuel cell system of claim 1, further comprising: a cathode gas moistening unit disposed in said cathode inlet conduit downstream of whereat said cathode branch conduit branches from the cathode inlet conduit.

6. The fuel cell system of claim 3, further comprising a fuel cell offgas system arranged to receive said cathode offgas and a mixture of said anode offgas and said portion of said cathode gas that has been branched off from said cathode inlet conduit after performance of a catalytic reaction.

7. The fuel cell system of claim 6, wherein said fuel cell offgas system includes a demoisturizing arrangement or/and a muffler.

8. The fuel cell system of claim 1, wherein said fuel cell system is for a vehicle.

9. A fuel cell system comprising:
a fuel cell having an anode region and a cathode region;
said fuel cell defining an anode inlet to permit feeding said anode region with hydrogen;
a cathode inlet conduit;
said fuel cell defining a cathode inlet to permit feeding said cathode region with oxygen at said cathode inlet via said cathode inlet conduit;
a cathode gas conveyor for conveying cathode gas into said cathode inlet conduit;
said fuel cell defining an anode outlet and a cathode outlet;
an anode outlet conduit for receiving anode offgas at said anode outlet;
a catalytic converter wherethrough said anode offgas flows in said anode outlet conduit;
a cathode outlet conduit receiving cathode offgas at said cathode outlet of said fuel cell;
a blower; and,
an air inlet conduit for introducing air as a mixed gas via said blower into said anode outlet conduit upstream of said catalytic converter.

10. The fuel cell system of claim 9, wherein said fuel cell system is for a vehicle.

11. A method of operating a fuel cell system, including: a fuel cell having an anode region and a cathode region; said fuel cell defining an anode inlet to permit feeding said anode region with hydrogen; a cathode inlet conduit; said fuel cell defining a cathode inlet to permit feeding said cathode region with oxygen at said cathode inlet via said cathode inlet conduit; a cathode gas conveyor for conveying cathode gas into said cathode inlet conduit; said fuel cell defining an anode outlet and a cathode outlet; an anode outlet conduit for receiving anode offgas at said anode outlet; a catalytic converter wherethrough said anode offgas flows in said anode outlet conduit; a cathode outlet conduit for receiving cathode offgas at said cathode outlet of said fuel cell; and, a cathode branch conduit connecting said cathode inlet conduit to said anode outlet conduit upstream of said catalytic converter; the method comprising:
directing the anode offgas released at the anode outlet of the fuel cell through the catalytic converter to reduce hydrogen content in the anode offgas; and,
adding a portion of the cathode gas to be fed in from the cathode inlet to the fuel cell or adding air as a mixed gas to the anode offgas upstream of the catalytic converter.

12. The method of claim 11, wherein the portion of the cathode gas added to the anode offgas or the amount of the air as mixed gas added to the anode offgas is variable.

13. The method as claimed in claim 11, wherein the amount of the cathode gas added to the anode offgas or the amount of the air as mixed gas added to the anode offgas is adjusted depending on the hydrogen content in the anode offgas released at the anode outlet.

14. The method of claim 12, wherein the amount of the cathode gas added to the anode offgas or the amount of air as mixed gas added to the anode offgas is adjusted such that an at least stoichiometric oxygen/hydrogen ratio is provided for catalytic reaction in the catalytic converter.

15. The method of claim 14, wherein the amount of the cathode gas added to the anode offgas or the amount of air as mixed gas added to the anode offgas is adjusted such that a superstoichiometric oxygen/hydrogen ratio is provided for catalytic reaction in the catalytic converter.

16. The method of claim 14, wherein the amount of the cathode gas added to the anode offgas or the amount of air as mixed gas added to the anode offgas is adjusted such that the mixture of anode offgas and cathode gas supplied to the catalytic converter has a hydrogen content below a threshold hydrogen content.

17. The method as claimed in claim 16, wherein the threshold hydrogen content lies in the range from 4% by volume to 8% by volume.

18. The method of claim 11, wherein the cathode offgas leaving the fuel cell at a cathode outlet and the mixture that leaves the catalytic converter after performance of the catalytic reaction of the anode offgas and of the portion of the cathode gas added to the anode offgas or of the air as mixed gas are directed into a fuel cell offgas system.

19. The method of claim 11, wherein the method of operating a fuel cell system is for a vehicle.

20. A method of operating a fuel cell system includes a fuel cell having an anode region and a cathode region; said fuel cell defining an anode inlet to permit feeding said anode region with hydrogen; a cathode inlet conduit; said fuel cell defining a cathode inlet to permit feeding said cathode region with oxygen at said cathode inlet via said cathode inlet conduit; a cathode gas conveyor for conveying cathode gas into said cathode inlet conduit; said fuel cell defining an anode outlet and a cathode outlet; an anode outlet conduit for receiving anode offgas at said anode outlet; a catalytic converter wherethrough said anode offgas flows in said anode outlet conduit; a cathode outlet conduit receiving cathode offgas at said cathode outlet of said fuel cell; a blower; and, an air inlet conduit for introducing air as a mixed gas via said blower into said anode outlet conduit upstream of said catalytic converter; the method comprising:
directing the anode offgas released at the anode outlet of the fuel cell through the catalytic converter to reduce hydrogen content in the anode offgas; and,
adding a portion of the cathode gas to be fed in from the cathode inlet to the fuel cell or adding air as a mixed gas to the anode offgas upstream of the catalytic converter.
